(19) United States
(12) Patent Application Publication
(10) Pub. No.: US 2024/0097775 A1
(43) Pub. Date: Mar. 21, 2024

(54) WIRELESS COMMUNICATION METHOD, WIRELESS COMMUNICATION SYSTEM, AND WIRELESS COMMUNICATION PROGRAM

(71) Applicant: NIPPON TELEGRAPH AND TELEPHONE CORPORATION, Tokyo (JP)

(72) Inventors: Riku OMIYA, Musashino-shi, Tokyo (JP); Tomoaki OGAWA, Musashino-shi, Tokyo (JP); Tomoki MURAKAMI, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 18/275,233

(22) PCT Filed: Feb. 19, 2021
(86) PCT No.: PCT/JP2021/006387

§ 371 Date: Aug. 1, 2023

(51) Int. Cl. H04B 7/145

(52) U.S. Cl. CPC H04B 7/145

(57) ABSTRACT

A wireless communication system includes a sensor that acquires a position of an obstacle present between a transmitting station and a receiving station; an obstacle region detector that detects an obstacle region on the basis of the position acquired by the sensor; and a reflector region setter that sets, as a reflector setting region, a region on an opposite side of the obstacle region with reference to a tangent from the transmitting station toward the obstacle region and on an opposite side of the obstacle region with reference to a tangent from the receiving station toward the obstacle region. Further, there is a reflector selector that selects a reflector present in the reflector setting region among the plurality of reflectors, and a controller that controls communication such that the receiving station and the transmitting station perform wireless communication by radio waves reflected by the reflector selected by the reflector selector.

### TECHNICAL FIELD

The present invention relates to a wireless communication method, a wireless communication system, and a wireless communication program.

### BACKGROUND ART

In order to handle mobile traffic that has increased in recent years, it is important to improve frequency utilization efficiency. Therefore, attempts have been made to improve signal strength and reduce interference by actively controlling the radio wave propagation environment itself. For example, Non Patent Literature 1 discloses a technology of varying a radio wave propagation environment by using a repeater such as a reflector in combination.

### CITATION LIST

### Non Patent Literature

Non Patent Literature 1: Riku Omiya and 5 other persons, “Interijentokukan keiseinotameno musenchukeiki kumiawase sentakuhou (Method for selecting combination of wireless relays for forming intelligent space)”, Institute of Electronics, Information and Communication Engineers Society Convention, 2020

### SUMMARY OF INVENTION

### Technical Problem

In order to increase the effect of the reflector, it is necessary that both communication paths between the transmitting station and the reflector and between the reflector and the receiving station have a line-of-sight (LOS) environment in which there is no obstacle. In the conventional technology, it is difficult to determine whether or not each communication path is clear, and it is not possible to select and use an effective reflector.

The present invention has been made in view of the above-described problems. An object of the present invention is to provide a wireless communication system, a wireless communication method, and a wireless communication program capable of securing a communication path in a line-of-sight environment.

### Solution to Problem

A wireless communication system according to an aspect of the present invention is a wireless communication system in which radio waves transmitted from a transmitting station toward a receiving station are reflected by a plurality of reflectors. This wireless communication system includes: a sensor unit that acquires data related to a position of an obstacle present between a transmitting station and a receiving station; an obstacle region detection unit that detects an obstacle region which is a region where the obstacle is present on the basis of the data acquired by the sensor unit; a reflector region setting unit that sets, as a reflector setting region, a region on an opposite side of the obstacle region with reference to a tangent from the transmitting station toward the obstacle region and on an opposite side of the obstacle region with reference to a tangent from the receiving station toward the obstacle region; a reflector selection unit that selects a reflector present in the reflector setting region among the plurality of reflectors; and a control unit that controls communication such that the receiving station and the transmitting station perform wireless communication by radio waves reflected by the reflector selected by the reflector selection unit.

In addition, a wireless communication method according to an aspect of the present invention is a wireless communication method in which radio waves transmitted from a transmitting station toward a receiving station are reflected by a plurality of reflectors. This wireless communication method includes: a sensor step of acquiring data related to a position of an obstacle present between the transmitting station and the receiving station; an obstacle region detection step of detecting an obstacle region which is a region where the obstacle is present on the basis of the data acquired by the sensor step; a reflector region setting step of setting, as a reflector setting region, a region on an opposite side of the obstacle region with reference to a tangent from the transmitting station toward the obstacle region and on an opposite side of the obstacle region with reference to a tangent from the receiving station toward the obstacle region; a reflector selection step of selecting a reflector present in the reflector setting region among the plurality of reflectors; and a control step of controlling communication such that the receiving station and the transmitting station perform wireless communication by radio waves reflected by the reflector selected by the reflector selection step.

### Advantageous Effects of Invention

According to the present invention, it is possible to secure a communication path in a line-of-sight environment.

### BRIEF DESCRIPTION OF DRAWINGS

FIG. 1 is a diagram schematically illustrating a configuration example of a wireless communication system according to Embodiment 1.

FIG. 2 is a functional block diagram illustrating main functions of the wireless communication system according to Embodiment 1.

FIG. 3 is a flowchart illustrating an operation example of the wireless communication system according to Embodiment 1.

FIG. 4 is a diagram illustrating a modification of the wireless communication system according to Embodiment 1.

FIG. 5 is a diagram illustrating a hardware configuration example for implementing each function of the wireless communication system.

### DESCRIPTION OF EMBODIMENTS

Hereinafter, an embodiment will be described with reference to the accompanying drawings. In the present disclosure, redundant description will be simplified or omitted as appropriate. Note that the present disclosure is not limited to the embodiments described below. The present disclosure may include various modifications and combinations of configurations disclosed by the following embodiments without departing from the spirit of the present disclosure.

### Embodiment 1

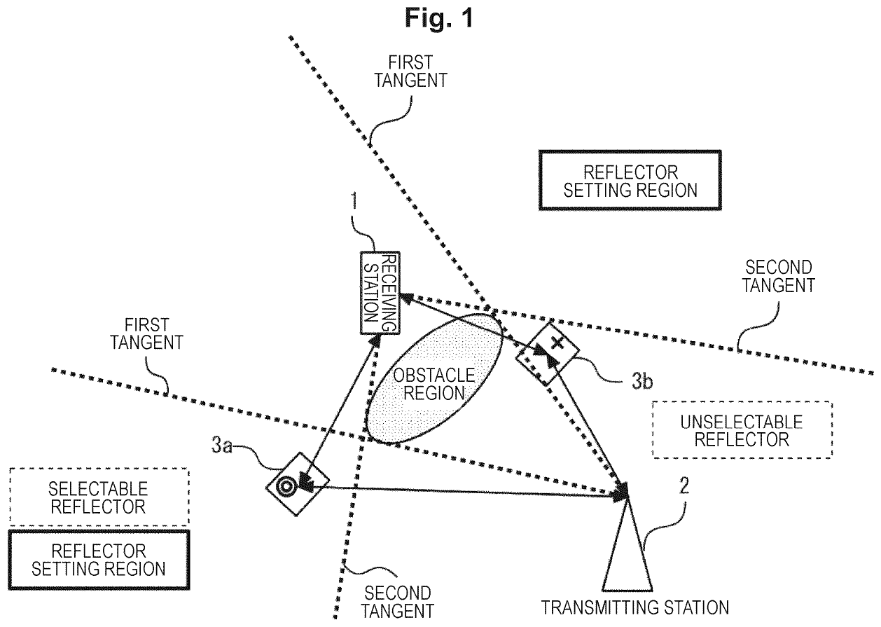

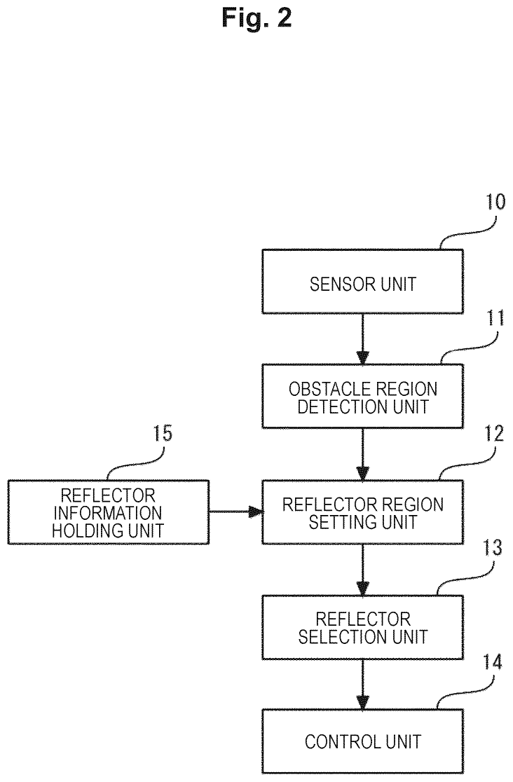

FIG. 1 is a diagram schematically illustrating a configuration example of a wireless communication system according to Embodiment 1. FIG. 2 is a functional block diagram illustrating main functions of the wireless communication system according to Embodiment 1.

The wireless communication system according to the present embodiment is a system that achieves a good radio wave propagation environment by reflecting radio waves transmitted by a transmitting station 2 toward a receiving station 1 by a plurality of reflectors. The wireless communication system can be implemented as a single device or can be implemented by cooperation of a plurality of devices.

Each of the plurality of reflectors forming the wireless communication system has a function of reflecting and relaying radio waves transmitted by the transmitting station 2. As an example, the plurality of reflectors include a first reflector 3a and a second reflector 3b.

As illustrated in FIG. 2, the wireless communication system according to the present embodiment includes a sensor unit 10, an obstacle region detection unit 11, a reflector region setting unit 12, a reflector selection unit 13, and a control unit 14. The wireless communication system according to the present embodiment also includes a reflector information holding unit 15 as a database that holds information such as positions of a plurality of reflectors.

The sensor unit 10 acquires data related to the position of an obstacle present between the transmitting station 2 and the receiving station 1. Note that “obstacle” in the present disclosure refers to an object that shields radio waves transmitted by the transmitting station 2.

The sensor unit 10 is a sensing device for detecting a position of an obstacle present in a radio wave propagation environment implemented by the wireless communication system. The sensor unit 10 corresponds to, for example, a 3D laser scanner that acquires point cloud data, a camera that captures an actual image, or the like. Note that the types of devices forming the sensor unit 10 and the types of data acquired by the sensor unit 10 are not limited. The sensor unit 10 can be formed in any manner as long as it can acquire data for detecting the position of an obstacle.

The sensor unit 10 outputs acquired data to the obstacle region detection unit 11. The obstacle region detection unit 11 detects an obstacle region which is a region where an obstacle is present on the basis of data acquired by the sensor unit 10. The obstacle region detection unit 11 outputs the detected obstacle region data to the reflector region setting unit 12.

The reflector region setting unit 12 sets a reflector setting region on the basis of the obstacle region data detected by the obstacle region detection unit 11. In setting the reflector setting region, as illustrated in FIG. 1, a first tangent from the transmitting station 2 toward the obstacle region and a second tangent from the receiving station 1 toward the obstacle region are drawn. Then, a region on the opposite side of the obstacle region with reference to the first tangent and on the opposite side of the obstacle region with reference to the second tangent is set as the reflector setting region.

The reflector region setting unit 12 extracts data of a reflector present in the set reflector setting region on the basis of data held in the reflector information holding unit 15. The reflector region setting unit 12 outputs the extracted reflector data to the reflector selection unit 13.

The reflector selection unit 13 selects a reflector to be used in the wireless communication system on the basis of data output from the reflector region setting unit 12. The reflector selection unit 13 selects a reflector present in the reflector setting region from among the plurality of reflectors.

The control unit 14 controls each unit forming the wireless communication system. Specifically, the control unit 14 controls communication and the like among the receiving station 1, the transmitting station 2, and each reflector. In the present embodiment, the control unit 14 controls communication so that the receiving station 1 and the transmitting station 2 perform wireless communication by the radio waves reflected by the reflector selected by the reflector selection unit 13.

In the example illustrated in FIG. 1, the first reflector 3a is located in the reflector setting region. The first reflector 3a is a reflector selectable by the reflector selection unit 13. On the other hand, the second reflector 3b is located outside the reflector setting region. The second reflector 3b is a reflector that is unselectable by the reflector selection unit 13.

In the example illustrated in FIG. 1, there is no obstacle region between the first reflector 3a located in the reflector setting region and the transmitting station 2. The communication path between the first reflector 3a and the transmitting station 2 is a line-of-sight communication path. Similarly, there is no obstacle region between the first reflector 3a located in the reflector setting region and the receiving station 1. The communication path between the first reflector 3a and the receiving station 1 is a line-of-sight communication path.

In the example illustrated in FIG. 1, there is no obstacle region between the second reflector 3b and the transmitting station 2. The communication path between the first reflector 3a and the transmitting station 2 is a line-of-sight communication path. However, there is an obstacle region between the second reflector 3b located outside the reflector setting region and the receiving station 1. The communication path between the second reflector 3b and the receiving station 1 is not a line-of-sight communication path.

In the example illustrated in FIG. 1, the first reflector 3a is selected by the reflector selection unit 13. As a result, both the communication path between the first reflector 3a and the transmitting station 2 and the communication path between the first reflector 3a and the receiving station 1 can be set as the line-of-sight environment.

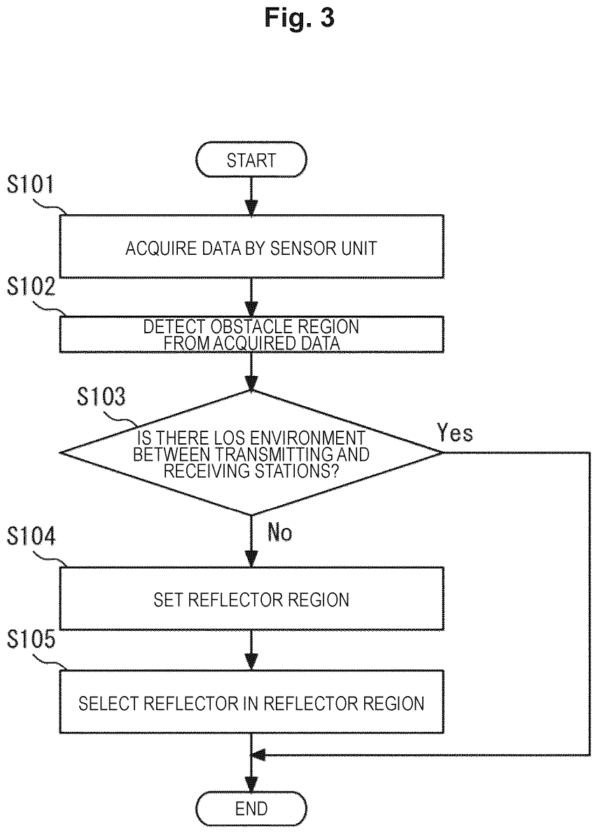

Next, a specific operation example of the wireless communication system according to the present embodiment will be described. FIG. 3 is a flowchart illustrating an operation example of the wireless communication system according to Embodiment 1.

First, the sensor unit 10 acquires data related to the position of an obstacle (S101). Then, the obstacle region detection unit 11 detects an obstacle region on the basis of the acquired data (S102).

Next, it is determined whether a line-of-sight environment is present between the transmitting station 2 and the receiving station 1 (S103). A case where a line-of-sight environment is present between the transmitting station 2 and the receiving station 1 means that there is no obstacle region between the transmitting station 2 and the receiving station 1. The determination in S103 is made on the basis of the obstacle region data detected by the obstacle region detection unit 11. Note that the determination in S103 may be made by the obstacle region detection unit 11, or a determination unit having a function of making the determination may be separately provided.

When a line-of-sight environment is present between the transmitting station 2 and the receiving station 1, no subsequent processing is performed, and communication is performed between the transmitting station 2 and the receiving station 1 without relaying by the reflector.

When a line-of-sight environment is not present between the transmitting station 2 and the receiving station 1, that is, when the obstacle region is present between the transmitting station 2 and the receiving station 1, the following processing is performed.

When a line-of-sight environment is not present between the transmitting station 2 and the receiving station 1, a reflector region is set by the reflector region setting unit 12 as described above (S104). Then, the reflector in the reflector region is selected by the reflector selection unit 13, and the control unit 14 performs control to perform communication using the reflector (S105).

According to the wireless communication system configured as described above, it is possible to secure a communication path in a line-of-sight environment. Note that each function of the wireless communication system can also be implemented as a wireless communication method.

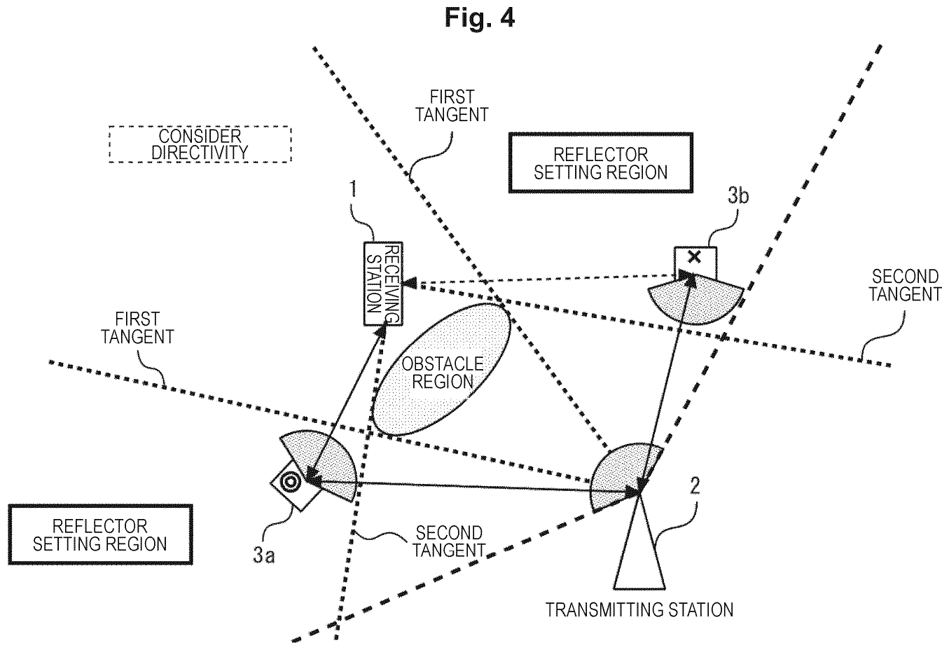

FIG. 4 is a diagram illustrating a modification of the wireless communication system according to Embodiment 1. The present modification is characterized by considering the directivity of a transmitting station 2 and the directivity of each reflector.

Specifically, in the present modification, a reflector selection unit 13 selects, from among reflectors present in a reflector setting region, a reflector that is present within the directivity range of the transmitting station 2 and in which the receiving station 1 is located within the directivity range of the reflector. In the example of FIG. 4, although a second reflector 3b is located in the reflector setting region, a receiving station 1 is not located within the directivity range of the second reflector 3b. On the other hand, a first reflector 3a is present in the reflector setting region and is present within the directivity range of the transmitting station 2. Then, the receiving station 1 is located within the directivity range of the first reflector 3a. In the example of FIG. 4, the first reflector 3a is selected and used. According to the present modification, a better radio wave propagation environment can be obtained by considering directivity.

Note that some or all of the functions of the wireless communication system according to the above embodiment and modification may be implemented using hardware such as an application specific integrated circuit (ASIC), a programmable logic device (PLD), or a field programmable gate array (FPGA). Each function of the wireless communication system may be implemented by a combination of dedicated hardware and software. In addition, some or all of the functions of the wireless communication system may be formed as a program executed by a processor such as a CPU. The program may be recorded in a computer-readable storage medium.

For example, the wireless communication system can be implemented by using a computer and a program, and the program can be recorded in a storage medium or provided through a network.

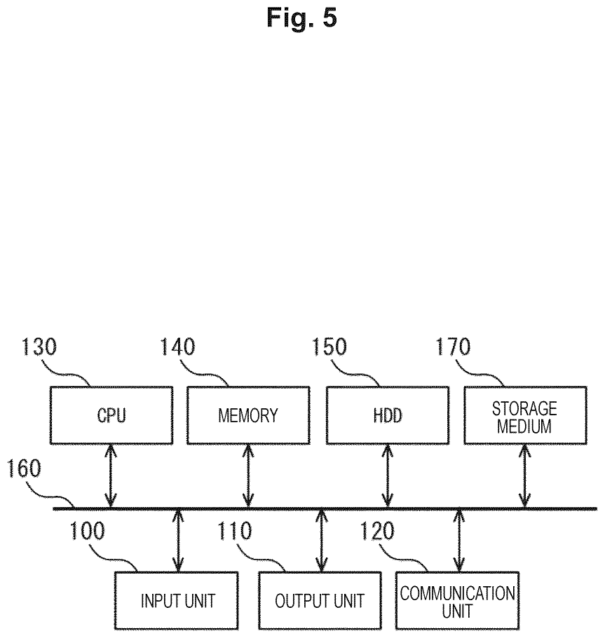

FIG. 5 is a diagram illustrating a hardware configuration example for implementing each function of the wireless communication system. As illustrated in FIG. 5, each function of the wireless communication system is implemented by, for example, an input unit 100, an output unit 110, a communication unit 120, a CPU 130, a memory 140, an HDD 150, and the like. The input unit 100, the output unit 110, the communication unit 120, the CPU 130, the memory 140, and the HDD 150 are connected via a bus 160 and have a function as a computer. In addition, a computer including the input unit 100, the output unit 110, the communication unit 120, the CPU 130, the memory 140, the HDD 150, and the like can input and output data to and from a computer-readable storage medium 170.

The input unit 100 is, for example, a keyboard, a mouse, or the like. The output unit 110 is, for example, a display device such as a display. The communication unit 120 is, for example, a wireless network interface.

The CPU 130 controls each unit forming the wireless communication system, and performs predetermined processing and the like. The memory 140 and the HDD 150 function as a storage unit that stores various data and the like.

The storage medium 170 stores a program for executing each function of the wireless communication system. Note that the architecture forming the wireless communication system is not limited to the example illustrated in FIG. 3.

The “computer” mentioned herein includes an OS and hardware such as peripheral devices. “Computer-readable storage medium” is, for example, a portable medium such as a flexible disk, a magneto-optical disk, a ROM, or a CD-ROM.

Furthermore, “computer-readable storage medium” may be a medium that dynamically holds a program for a short period of time like a communication line in a case where the program is transmitted via a network such as the Internet or a communication line such as a telephone line. In addition, “computer-readable storage medium” may be a medium that holds a program for a certain period of time, such as a volatile memory inside a computer serving as a server or a client.

### INDUSTRIAL APPLICABILITY

The wireless communication system, the wireless communication method, and the wireless communication program according to the present invention can be applied to, for example, a mobile base station that provides wireless communication.

### REFERENCE SIGNS LIST

1 Receiving station
2 Transmitting station
3a First reflector
3b Second reflector
10 Sensor unit
11 Obstacle region detection unit
12 Reflector region setting unit
13 Reflector selection unit
14 Control unit
15 Reflector information holding unit
100 Input unit
110 Output unit
120 Communication unit
130 CPU
140 Memory
150 HDD
160 Bus
170 Storage medium

1. A wireless communication system that reflects radio waves transmitted by a transmitting station toward a receiving station by a plurality of reflectors, the wireless communication system comprising:
a sensor that acquires data related to a position of an obstacle present between the transmitting station and the receiving station;
an obstacle region detector that detects an obstacle region which is a region where the obstacle is present on the basis of the data acquired by the sensor;
reflector region setting circuitry that sets, as a reflector setting region, a region on an opposite side of the obstacle region with reference to a tangent from the transmitting station toward the obstacle region and on an opposite side of the obstacle region with reference to a tangent from the receiving station toward the obstacle region;
reflector selection circuitry that selects a reflector present in the reflector setting region among the plurality of reflectors; and
control circuitry that controls communication such that the receiving station and the transmitting station perform wireless communication by radio waves reflected by the reflector selected by the reflector selection circuitry.

2. The wireless communication system according to claim 1, wherein:
the reflector selection circuitry selects one of the reflectors present in the reflector setting region that is present within a range of directivity of the transmitting station and in which the receiving station is located within a range of directivity of the reflector.

3. A wireless communication method for reflecting radio waves transmitted by a transmitting station toward a receiving station by a plurality of reflectors, the method comprising:
acquiring data related to a position of an obstacle present between the transmitting station and the receiving station;
detecting an obstacle region which is a region where the obstacle is present on the basis of the data acquired by the acquiring;
setting, as a reflector setting region, a region on an opposite side of the obstacle region with reference to a tangent from the transmitting station toward the obstacle region and on an opposite side of the obstacle region with reference to a tangent from the receiving station toward the obstacle region;
selecting a reflector present in the reflector setting region among the plurality of reflectors; and
controlling communication such that the receiving station and the transmitting station perform wireless communication by radio waves reflected by the reflector which was selected.

4. The wireless communication method according to claim 3, wherein:
the selecting selects one of the reflectors present in the reflector setting region that is present within a range of directivity of the transmitting station and in which the receiving station is located within a range of directivity of the reflector.

5. A non-transitory computer readable medium storing a wireless communication program for causing a computer to function as the wireless communication system according to claim 1.

6. A non-transitory computer readable medium storing a wireless communication program for causing a computer to perform the method of claim 3.
